(19) United States
(12) Patent Application Publication
(10) Pub. No.: US 2025/0207690 A1
(43) Pub. Date: Jun. 26, 2025

(54) Cable holder

(71) Applicant: Liang WU, Ningbo City (CN)

(72) Inventor: Liang WU, Ningbo City (CN)

(21) Appl. No.: 18/393,169

(22) Filed: Dec. 21, 2023

(51) Int. Cl. F16L 3/06; F16B 47/00; H02G 3/02

(52) U.S. Cl. CPC F16L 3/06; F16B 47/00; H02G 3/02

(57) ABSTRACT

This application relates to a type of cable holder. The body of the cable holder is equipped with at least one threading hole for cables to pass through, and at least one elastic blocking tooth is set inside the threading hole. The root of the blocking tooth is fixed to the inner wall of the threading hole, and the blocking tooth extends from the inner wall towards the middle of the threading hole. If there are more than one blocking teeth in the same threading hole, a holding position for the cable to pass through and be holdered is formed between the outer ends of all the blocking teeth in the same threading hole. If there is only one blocking tooth in the same threading hole, the holding position is formed between the opposite inner wall and the outer end of the blocking tooth.

### FIELD OF THE INVENTION

This application relates to peripheral accessories for electronic devices, more specifically, to a type of cable holder.

### BACKGROUND

As the use of electrical and electronic devices has been increasing, the accompanying cables have also become more numerous, necessitating organization to avoid the inconvenience caused by tangled and piled cables. Currently, various cable holders, featuring one or more holes, are commonly used for organizing cables. These holes allow cables to pass through, enabling separation and easy identification of each cable by users. However, the inventor has found that during the use of these cable holders, cables can move within the holes, and if the plugs at the ends of the cables are relatively small, there is a possibility that the cables may fall out of the holes, indicating a need for improvement.

### SUMMARY

The objective of this application is to overcome the shortcomings of the existing technology by providing a cable holder designed to prevent cables from falling out of the holder.

According to one aspect, this application provides the following technical solution: a cable holder whose body is equipped with at least one threading hole through which cables can pass, with at least one elastic blocking tooth set inside the threading hole. The root of the blocking tooth is fixed to the inner wall of the threading hole, extending from the inner wall towards the middle of the threading hole. If there are more than one blocking teeth in the same threading hole, a holding position for the cable to pass through and be holdered is formed between the outer ends of all the blocking teeth in the same threading hole. If there is only one blocking tooth in the same threading hole, the holding position is formed between the opposite inner wall and the outer end of the blocking tooth.

According to another aspect, this application also provides another type of cable holder, where the body of the cable holder is equipped with at least one threading hole, and an elastic surround is set inside the threading hole. The surround is fixed to the inner wall of the threading hole and extends circumferentially along the inner wall, with the surround having at least one holding position for the cable to pass through and be holdered.

The beneficial effect of this application compared to the existing technology is that the cable holder's threading holes are equipped with blocking teeth or a surround, forming a holding position for the cable. Therefore, when a cable passes through the threading hole, it is held by the blocking teeth or surround. There exists a relative frictional force between the cable and the blocking teeth or surround, preventing the cable from falling out of the holder in the absence of external force, thus enhancing its ease of use.

The above description is only an overview of the technical solutions of this application. To better understand the technical means of this application, implementation can be carried out according to the contents of the specification. To make the above and other objectives, features, and advantages of this application more clear and understandable, the following preferred embodiments are cited and detailed explanations are provided below.

### BRIEF DESCRIPTION OF THE DRAWINGS

FIG. 1 is a perspective view of the cable holder in the first embodiment of this application.

FIG. 2 is a perspective view of the cable holder in the second embodiment of this application.

FIG. 3 is a perspective view of the cable holder in the third embodiment of this application.

FIG. 4 is a perspective view of the cable holder in the fourth embodiment of this application.

FIG. 5 is a perspective view of the cable holder in the fifth embodiment of this application.

FIG. 6 is a perspective view of the cable holder in the sixth embodiment of this application.

FIG. 7 is a perspective view of the cable holder in the seventh embodiment of this application.

FIG. 8 is a perspective view of the cable holder in the eighth embodiment of this application.

FIG. 9 is a perspective view of the cable holder in the ninth embodiment of this application.

FIG. 10 is a perspective view of the cable holder in the tenth embodiment of this application.

It should be noted that the products shown in the above figures have been appropriately scaled down/up to fit the size of the drawings and to ensure clarity of the views, and this does not impose any limitations on the actual size of the products depicted.

### DETAILED DESCRIPTION OF EMBODIMENTS

To make the objectives, technical solutions, and advantages of this application clearer and more comprehensible, the following further detailed explanation is provided in conjunction with the accompanying drawings and specific embodiments.

The technical solutions in the embodiments of this application will be described clearly and completely in conjunction with the accompanying drawings. It should be noted that the embodiments described herein represent only a part of the embodiments of this application, and not all embodiments. All other embodiments obtained by those skilled in the art based on the embodiments in this application, without creative effort, fall within the scope of protection of this application.

### First Embodiment

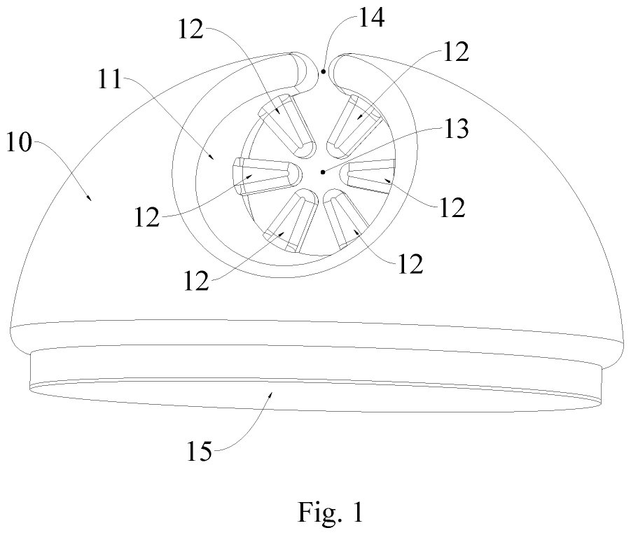

The first embodiment is a type of cable holder, as specifically illustrated in FIG. 1. The cable holder is overall shaped like a sphere cap, but this application does not restrict the cable holder to only the shape shown in FIG. 1.

As shown in FIG. 1, the body 10 of the cable holder is equipped with a circular threading hole 11 for the cable to pass through. Inside the threading hole 11, there are six elastic blocking teeth 12. The shape of the blocking teeth 12 can be cylindrical, conical, or frustoconical, etc., and this application is not limited in this respect. Each blocking tooth 12 is rooted in the inner wall of the threading hole 11 and extends from the inner wall towards the middle of the threading hole 11. In the first embodiment, the blocking teeth 12 are made of an elastic plastic material. The material of the body 10 of the cable holder is the same as that of the blocking teeth 12, and both the body 10 and the blocking teeth 12 are integrally injection molded, which enhances the overall manufacturing speed and reduces production costs.

In the first embodiment, as shown in FIG. 1, there are more than one blocking teeth 12 within the same threading hole 11, thus forming a holding position 13 between the outer ends of all the blocking teeth 12 for the cable to pass through and be holdered, with the size of the holding position 13 being smaller than the cross-sectional size of the cable. Additionally, the sidewall of the threading hole 11 has an opening 14, which connects to the threading hole 11. In use, the cable is inserted through the opening 14 into the threading hole 11, and guided into the central holding position 13, where the blocking teeth 12 are deformed by the cable, generating a holdering force by all six blocking teeth 12 on the cable, preventing the cable from falling out of the holder in the absence of external force, thus enhancing its ease of use.

Furthermore, as shown in FIG. 1, the base of the body 10 of the cable holder is equipped with a fixing component 15, which is an adhesive layer or a suction cup. The fixing component 15 is used to attach the cable holder to an external object, such as a desktop, wall, etc.

### Second Embodiment

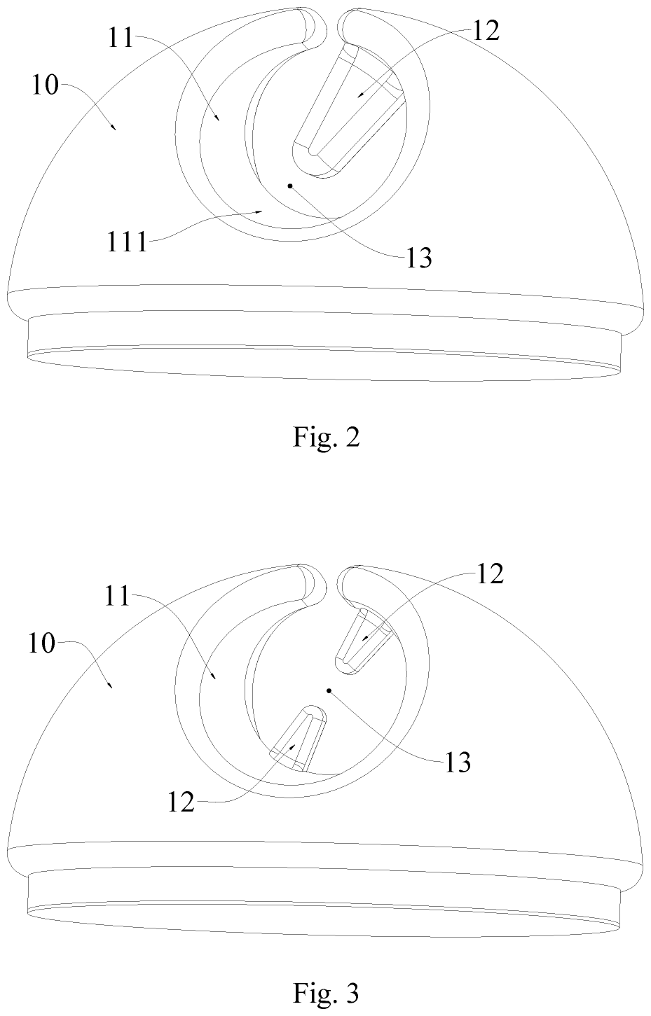

The second embodiment is a type of cable holder, with its specific structure shown in FIG. 2. The difference between the cable holder in this embodiment and the first embodiment is that the threading hole 11 of the cable holder body 10 in the second embodiment is equipped with only one blocking tooth 12. In the second embodiment, there is only one blocking tooth 12 within the same threading hole 11, and a holding position 13 for the cable to pass through and be holdered is formed between the opposite inner wall 111 and the outer end of the blocking tooth 12. In use, the cable is guided into the central holding position 13, where the blocking tooth 12 is deformed by the cable, generating a holdering force with the opposite inner wall 111 on the cable.

### Third Embodiment

The third embodiment is a type of cable holder, with its specific structure shown in FIG. 3. The difference between this cable holder and the first embodiment is that the threading hole 11 of the cable holder body 10 in the third embodiment is equipped with two blocking teeth 12. In the third embodiment, there are two blocking teeth 12 within the same threading hole 11, thus forming a holding position 13 between the outer ends of the two opposing blocking teeth 12 for the cable to pass through and be holdered. In use, the cable is guided into the central holding position 13, where the blocking teeth 12 are deformed by the cable, generating a holdering force by the two opposing blocking teeth 12 on the cable.

### Fourth Embodiment

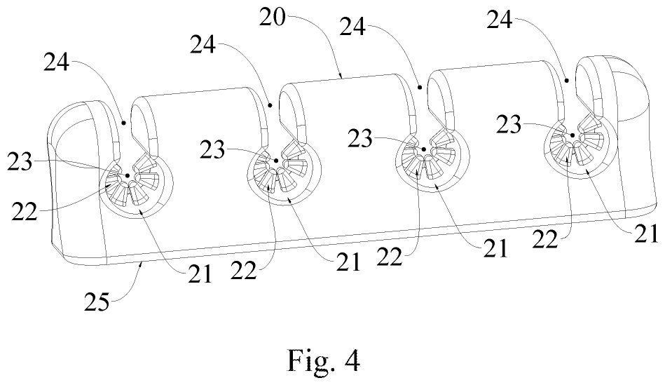

The fourth embodiment describes a type of cable holder, with its specific structure shown in FIG. 4. The cable holder is elongated and its body 20 is equipped with four parallel circular threading holes 21, each of which can accommodate a cable. Inside each threading hole 21, there are six elastic blocking teeth 22. The root of each blocking tooth 22 is fixed to the inner wall of the threading hole 21, and each extends from the inner wall towards the center of the threading hole 21. In this embodiment, the blocking teeth 22 are made of an elastic plastic material. The material of the body 20 of the cable holder is consistent with that of the blocking teeth 22, and both the body 20 and the blocking teeth 22 are integrally injection-molded. This design enhances the manufacturing speed and reduces production costs of the cable holder.

As illustrated in FIG. 4 of the fourth embodiment, there are more than one blocking tooth 22 within the same threading hole 21. Consequently, all the blocking teeth 22 within the same threading hole 21 surround and form a holding position 23 for the cable to pass through and be holdered. Additionally, the sidewall of the threading hole 21 features an opening 24, which connects to the threading hole 21. In use, the cable is inserted through the opening 24 into the threading hole 21, and guided into the central holding position 23. The blocking teeth 22 are deformed by the pressure exerted by the cable, thereby generating a holdering force by all six blocking teeth 22 on the cable. This design prevents the cable from automatically falling out of the holder in the absence of external force, thus enhancing its ease of use.

Furthermore, as shown in FIG. 4, the base of the body 20 of the cable holder is equipped with a fixing component 25, which may be an adhesive layer or a suction cup. The fixing component 25 is used for attaching the cable holder to an external object, such as a desktop, wall, etc.

### Fifth Embodiment

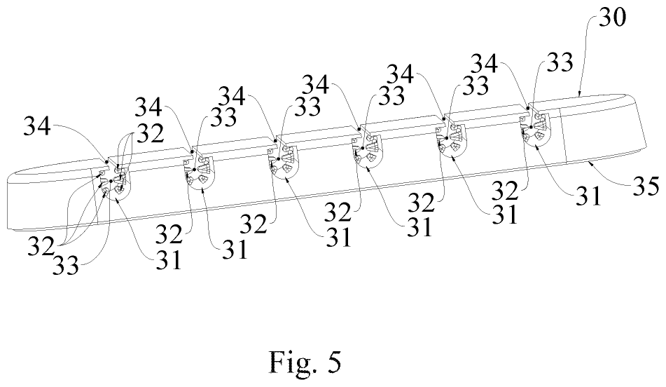

The fifth embodiment describes a type of cable holder, with its specific structure shown in FIG. 5. The cable holder is flat and plate-shaped, with its body 30 equipped with six parallel arch-shaped threading holes 31, each capable of accommodating a cable. Inside each threading hole 31, there are six elastic blocking teeth 32. The root of each blocking tooth 32 is fixed to the inner wall of the threading hole 31, and each extends from the inner wall towards the center of the threading hole 31. In this embodiment, the blocking teeth 32 are made of an elastic plastic material. The material of the body 30 of the cable holder is consistent with that of the blocking teeth 32, and both the body 30 and the blocking teeth 32 are integrally injection-molded, which enhances the manufacturing speed and reduces the production costs of the cable holder.

As illustrated in FIG. 5 of the fifth embodiment, there are more than one blocking tooth 32 within the same threading hole 31. Consequently, all the blocking teeth 32 within the same threading hole 31 surround and form a holding position 33 for the cable to pass through and be holdered. Additionally, the sidewall of the threading hole 31 features an opening 34, which connects to the threading hole 31. In use, the cable is inserted through the opening 34 into the threading hole 31, and guided into the central holding position 33. The blocking teeth 32 are deformed by the pressure exerted by the cable, thereby generating a holdering force by all six blocking teeth 32 on the cable. This design prevents the cable from automatically falling out of the holder in the absence of external force, thus enhancing its ease of use.

Furthermore, as shown in FIG. 5, the base of the body 30 of the cable holder is equipped with a fixing component 35, which may be an adhesive layer or a suction cup. The fixing component 35 is used for attaching the cable holder to an external object, such as a desktop, wall, etc.

### Sixth Embodiment

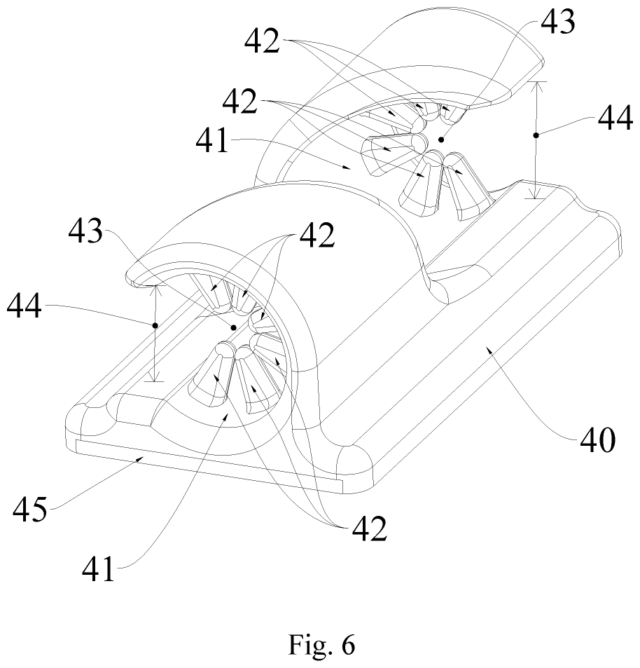

The sixth embodiment describes a type of cable holder, with its specific structure shown in FIG. 6. The body 40 of the cable holder is equipped with two threading holes 41, which are coaxial with each other, and the cable is required to pass through both threading holes 41 simultaneously during use. Inside each threading hole 41, there are six elastic blocking teeth 42. The root of each blocking tooth 42 is fixed to the inner wall of the threading hole 41, and each extends from the inner wall towards the center of the threading hole 41. In this embodiment, the blocking teeth 42 are made of an elastic plastic material. The material of the body 40 of the cable holder is consistent with that of the blocking teeth 42, and both the body 40 and the blocking teeth 42 are integrally injection-molded.

As illustrated in FIG. 6 of the sixth embodiment, there are more than one blocking tooth 42 within the same threading hole 41. Consequently, all the blocking teeth 42 within the same threading hole 41 surround and form a holding position 43 for the cable to pass through and be holdered. Additionally, the sidewall of the threading hole 41 features openings 44, which connect to the threading hole 41, and the openings 44 of the two threading holes 41 face in opposite directions. In use, the cable is inserted through each of the two openings 44 into the corresponding threading holes 41, and guided into the central holding position 43. The blocking teeth 42 are deformed by the pressure exerted by the cable, thereby generating a holdering force by all six blocking teeth 42 in each threading hole 41, resulting in a total of twelve blocking teeth 42 holdering the cable, which enhances the fixation effect on the cable.

Furthermore, as shown in FIG. 6, the base of the body 40 of the cable holder is equipped with a fixing component 45, which may be an adhesive layer or a suction cup. The fixing component 45 is used for attaching the cable holder to an external object, such as a desktop, wall, etc.

### Seventh Embodiment

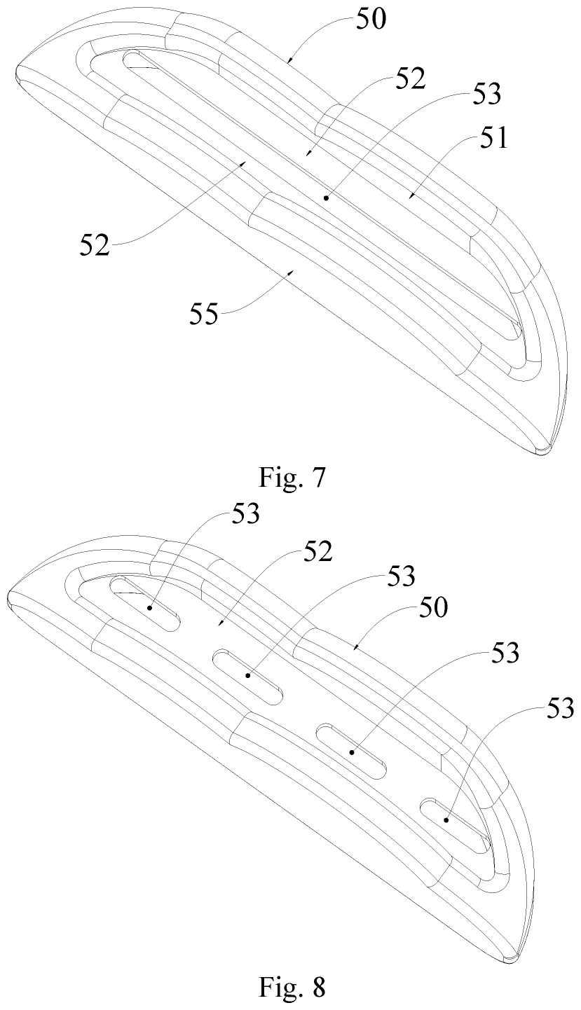

The seventh embodiment describes a type of cable holder, with its specific structure shown in FIG. 7. The body 50 of the cable holder is equipped with a threading hole 51 for the cable to pass through, and within this threading hole 51, there is an elastic surround 52. As shown in FIG. 7, the surround 52 is fixed to the inner wall of the threading hole 51 and extends circumferentially along the inner wall. The surround 52 features a longitudinal holding position 53 for the cable to pass through and be holdered. The surround 52 can be made of an elastic plastic material. The material of the body 50 of the cable holder is consistent with that of the surround 52, and both the body 50 and the surround 52 are made as a single piece, which enhances the manufacturing speed and reduces the production costs. In use, since the surround 52 is elastic and deformable, the end of the cable such as a USB plug, power plug, etc. can be passed directly through the holding position 53. The width of the holding position 53 is set smaller than the diameter of the cable, therefore, the surround 52 will also be deformed by the pressure of the cable, generating a holdering force on the cable. This design prevents the cable from automatically falling out of the holder in the absence of external force, thus enhancing its ease of use.

Furthermore, as shown in FIG. 7, the base of the body 50 of the cable holder is equipped with a fixing component 55, which may be an adhesive layer or a suction cup. The fixing component 55 is used for attaching the cable holder to an external object, such as a desktop, wall, etc.

### Eighth Embodiment

The eighth embodiment describes a type of cable holder, with its specific structure shown in FIG. 8. The difference between the cable holder in this embodiment and the seventh embodiment lies in that the surround 52 of the body 50 of the cable holder in the eighth embodiment has four parallel longitudinal holding positions 53 for the cable to pass through and be holdered. In practice, the number of holding positions 53 in the surround 52 can be determined according to need, and this application does not limit this number.

### Ninth Embodiment

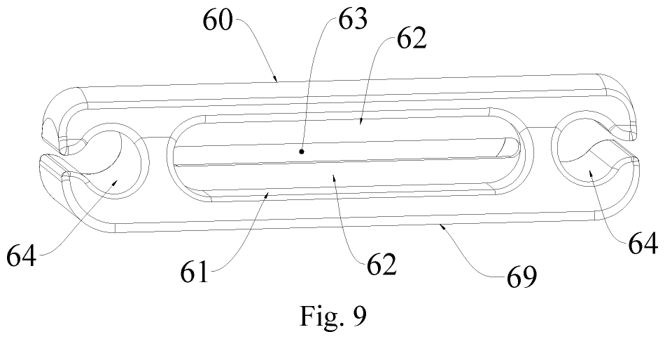

The ninth embodiment describes a type of cable holder, with its specific structure shown in FIG. 9. The body 60 of the cable holder has a central threading hole 61 with a runway-shaped cross-section for the cable to pass through, and within this threading hole 61, there is an elastic surround 62. As shown in FIG. 9, the surround 62 is fixed to the inner wall of the threading hole 61 and extends circumferentially along the inner wall. The middle of the surround 62 features a longitudinal holding position 63 for the cable to pass through and be holdered. The surround 62 can be made of an elastic plastic material. The material of the body 60 of the cable holder is consistent with that of the surround 62, and both the body 60 and the surround 62 are made as a single piece, which enhances the manufacturing speed and reduces the production costs. In use, since the surround 62 is elastic and deformable, the end of the cable such as a USB plug, power plug, etc. can be directly inserted through the holding position 63. The width of the holding position 63 is set smaller than the diameter of the cable, therefore, the surround 62 will also be deformed by the pressure of the cable, generating a holdering force on the cable. This design prevents the cable from automatically falling out of the holder in the absence of external force, thus enhancing its ease of use.

As shown in FIG. 9, there are side holes 64 on both sides of the body 60 of the cable holder, which are used for the cable to pass through. In other embodiments, a side hole may be provided on only one side of the body of the cable holder.

Furthermore, as shown in FIG. 9, the base of the body 60 of the cable holder is equipped with a fixing component 69, which may be an adhesive layer or a suction cup. The fixing component 69 is used for attaching the cable holder to an external object, such as a desktop, wall, etc.

### Tenth Embodiment

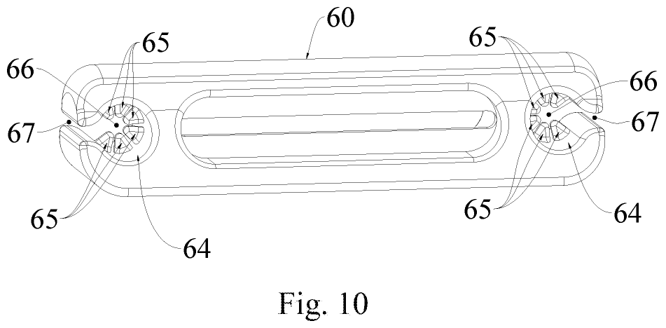

The tenth embodiment describes a type of cable holder, with its specific structure shown in FIG. 10. The difference between the cable holder in this embodiment and the ninth embodiment lies in that the side holes 64 on both sides of the body 60 of the cable holder in the tenth embodiment are equipped with elastic blocking teeth. In other embodiments, one side of the cable holder may have elastic blocking teeth in the side hole, while the other side does not.

As shown in FIG. 10, inside each side hole 64, there are six elastic blocking teeth 65. The root of each blocking tooth 65 is fixed to the inner wall of the side hole 64, and each extends from the inner wall towards the center of the side hole 64. The blocking teeth 65 are made of an elastic plastic material. The material of the body 60 of the cable holder is consistent with that of the blocking teeth 65, and both the body 60 and the blocking teeth 65 are integrally injection-molded. This enhances the manufacturing speed and reduces the production costs of the cable holder.

As illustrated in FIG. 10, there are more than one blocking tooth 65 within the same side hole 64. Consequently, all the blocking teeth 65 within the same side hole 64 surround and form a holding position 66 for the cable to pass through and be holdered. Additionally, the sidewall of the side hole 64 features an opening 67, which connects to the side hole 64. In use, the cable is inserted through the opening 67 into the side hole 64, and guided into the central holding position 66. The blocking teeth 65 are deformed by the pressure exerted by the cable, thereby generating a holdering force by all six blocking teeth 65 on the cable. This design prevents the cable from automatically falling out of the holder in the absence of external force, thus enhancing its ease of use.

In other embodiments, if there is only one blocking tooth within the same side hole, the holding position for the cable to pass through and be holdered is formed between the opposite inner wall and the outer end of the blocking tooth, similar to the structure of the threading hole and blocking tooth shown in FIG. 2.

In this document, references to ‘embodiments,’ as demonstrated in the specific features, structures, or characteristics described in conjunction with the embodiments, are intended to be included in at least one embodiment of this application. The phrase ‘in one embodiment’ appearing at various locations throughout this specification does not necessarily refer to the same embodiment, nor is it mutually exclusive or alternative to other embodiments. It is understood, both explicitly and implicitly, by those skilled in the art that the embodiments described herein can be combined with other embodiments.

In the description of this application, it should be understood that terms such as ‘center,’ ‘longitudinal,’ ‘transverse’, ‘length,’ ‘width,’ ‘thickness,’ ‘upper,’ ‘lower,’ ‘front,’ ‘back,’ ‘left,’ ‘right,’ ‘vertical,’ ‘horizontal,’ ‘top,’ ‘bottom,’ ‘inner,’ ‘outer,’ ‘clockwise,’ ‘counterclockwise,’ and the like, indicating orientations or positional relationships, are based on the orientations or positional relationships shown in the drawings. They are intended for ease of description and simplification of the application and are not indicative or suggestive that the devices or elements must have specific orientations, be constructed and operated in specific orientations, and thus should not be considered limiting to the application.

Moreover, terms like ‘first’ and ‘second’ are used only for descriptive purposes and should not be construed as indicating or implying relative importance or implicitly indicating the quantity of the indicated technical features. Thus, the features defined with ‘first’ and ‘second’ could include one or more of such features. In the description of this application, ‘a plurality’ means two or more unless explicitly defined otherwise.

In this application, unless explicitly specified and limited, a first feature ‘above’ or ‘below’ a second feature can include the first and second features being in direct contact, or the first and second features not being in direct contact but instead being contacted through other features between them. Moreover, the first feature ‘above,’ ‘over,’ or ‘on top of’ the second feature includes the first feature being directly above or obliquely above the second feature, or merely indicating that the first feature has a higher level than the second feature. The first feature ‘below,’ ‘under,’ or ‘beneath’ the second feature includes the first feature being directly below or obliquely below the second feature, or merely indicating that the first feature has a lower level than the second feature.

In the description of this specification, the referential terms ‘an embodiment,’ ‘some embodiments,’ ‘an example,’ ‘a particular example,’ or ‘some examples’ mean that a particular feature, structure, material, or characteristic described in connection with the embodiment or example is included in at least one embodiment or example of the application. In this specification, such referential use of the terms should not be construed as necessarily all referring to the same embodiment or example. Furthermore, the particular features, structures, materials, or characteristics described may be combined in any suitable manner in one or more embodiments or examples. Moreover, various embodiments or examples described by the technical personnel in this field can be combined and arranged.

The above descriptions of embodiments are provided to enable any person skilled in the art to make or use the application and are provided to particularly point out and distinctly claim the subject matter of the application. The scope of the application should be determined by the appended claims.

What is claimed is:

1. A cable holder, characterized in that, the cable holder comprises a body, provided with at least one threading hole through which the cable passes, and at least one elastic blocking tooth set inside the threading hole, the at least one elastic blocking tooth comprising a root and an outer end each, the root of the blocking tooth being fixed to an inner wall of the threading hole and extending from the inner wall towards the middle of the threading hole; if there are more than one blocking teeth in the same threading hole, a holding position for the cable to pass through and be holdered being formed between the outer ends of all the blocking teeth in the same threading hole, and if there is only one blocking tooth in the same threading hole, the holding position being formed between the inner wall opposite to the blocking tooth and the outer end of the blocking tooth.

2. The cable holder of claim 1, characterized in that the sidewall of the threading hole is provided with an opening that communicates with the threading hole.

3. The cable holder of claim 2, characterized in that there are two threading holes and the two threading holes are coaxial with each other.

4. The cable holder of claim 3, characterized in that the openings of the two threading holes are oriented in two opposite directions.

5. The cable holder of claim 1, characterized in that the bottom of the body of the cable holder is provided with a fixing component used to fix the cable holder to an external object.

6. The cable holder of claim 5, characterized in that the fixing component is an adhesive layer or a suction cup.

7. The cable holder of claim 1, characterized in that the blocking teeth are made of an elastic plastic material.

8. The cable holder of claim 7, characterized in that the material of the body of the cable holder is consistent with that of the blocking teeth, and the body and the blocking teeth are integrally formed.

9. A cable holder, comprising a body, characterized in that the body of the cable holder is provided with at least one threading hole through which the cable passes, and an elastic surround is set in the threading hole, with the surround being fixed to an inner wall of the threading hole and extending circumferentially along the inner wall, and the surround having at least one holding position for the cable to pass through and be holdered.

10. The cable holder of claim 9, characterized in that the surround is made of an elastic plastic material.

11. The cable holder of claim 10, characterized in that the material of the body of the cable holder is consistent with that of the surround, and the body and surround are integrally formed.

12. The cable holder of claim 9, characterized in that the bottom of the body of the cable holder is provided with a fixing component used to fix the cable holder to an external object.

13. The cable holder of claim 12, characterized in that the fixing component is an adhesive layer or a suction cup.

14. The cable holder of claim 9, characterized in that at least one side holes is provided on either or both sides of the body of the cable holder, and the side holes are used for the cable to pass through.

15. The cable holder of claim 14, characterized in that at least one elastic blocking tooth is set inside the at least one side hole, with the root of the blocking tooth fixed to the inner wall of the side hole and extending from the inner wall towards the middle of the side hole; if there are more than one blocking teeth in the same side hole, a holding position for the cable to pass through and be holdered is formed between the outer ends of all the blocking teeth in the same side hole, and if there is only one blocking tooth in the same side hole, the holding position is formed between the opposite inner wall and the outer end of the blocking tooth.
